(19) United States
(12) Patent Application Publication
(10) Pub. No.: US 2018/0170662 A1
(43) Pub. Date: Jun. 21, 2018

(54) PORTION CAPSULE AND METHOD FOR PRODUCING A BEVERAGE BY MEANS OF A PORTION CAPSULE

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 15/735,770

(22) PCT Filed: Jun. 9, 2016
(86) PCT No.: PCT/EP2016/063215

§ 371 Date: Dec. 12, 2017

(30) Foreign Application Priority Data
Jun. 16, 2015 (DE) 10 2015 109 608.0

(51) Int. Cl. B65D 85/804

(52) U.S. Cl. CPC B65D 85/8043

(57) ABSTRACT

The invention relates to a portion capsule for producing a beverage, comprising a capsule body. Said capsule body has a capsule bottom, a side wall, a collar edge, and a lid. A cavity for accommodating a powdery, granular, or liquid beverage substrate is formed between the capsule bottom and the lid. A filter element is arranged in the cavity, and the filter element is produced of non-woven fiber material.

The present invention relates to a portion capsule for producing a beverage having a capsule body with a capsule bottom, a side wall and a collar edge and a lid, a cavity for receiving a pulverulent, granular or liquid beverage substrate being configured between the capsule bottom and the lid, and a filter element being arranged in the cavity, and the filter element being produced from nonwoven fiber material.

Portion capsules of this type are generally known from the prior art, for example WO 2012/038063, and are used, for example, for producing tea or coffee beverages in brewing machines. For this purpose, water is pressed through the portion capsule by a pump and a beverage substance is dissolved and/or extracted in the process. The portion capsules which are known from the prior art have the disadvantage, however, that they, and in particular the filter element, have a comparatively high pressure loss, that is to say the positive pressure which has to be provided by the pump of the brewing machine has to be substantially greater than 2 bar.

It was therefore the object of the present invention to provide a portion capsule with a filter element, which portion capsule has a low pressure loss in comparison with the prior art.

This object is achieved by way of a portion capsule fox producing a beverage having a capsule body with a capsule bottom, a side wall and a collar edge and a lid, a cavity for receiving a beverage substrate which is pulverulent, granular, in the form of loose leaves and/or liquid, and a filter element being arranged in the cavity, and the filter element being produced from nonwoven fiber material, and the filter element having an edge region which is connected to the collar edge of the capsule body and has a central region which is fastened to the capsule bottom, the side wall of the filter element being stretched.

The comments made in respect of this subject of the present invention likewise apply to the other subjects of the present invention, and vice versa.

In comparison with the prior art, the portion capsule according to the invention has the advantage that a simple and inexpensive nonwoven fiber material is used as sieve element. Said material is not flat and the side wall of the filter element is stretched and, as a consequence, the filter element has a comparatively large filter area. The central region of the filter element is fastened to the bottom of the capsule body, with the result that the filter element assumes a clearly defined position in the capsule body. All of this results in a comparatively low pressure loss of the portion capsule.

In the context of the present invention, the portion capsule comprises a preferably hermetically sealed portion capsule. This means that the beverage or food substrate which is situated in the portion capsule, for example coffee powder, soup powder or tea, is closed in a substantially aroma-tight manner with respect to the surroundings before the extraction and/or dissolving operation. However, the portion capsule does not have to be hermetically sealed, but rather can also be provided in a hermetically sealed packaging before its use, which packaging is then opened, for example manually. Portion capsules of this type are as a rule opened on at least one side, preferably two sides, that is to say can be flowed through by the preparation liquid without being pierced.

The portion capsules for producing a beverage or a food are preferably of frustoconical or cylindrical shape and are produced, for example, from a deep-drawn plastic film or using the plastic injection scolding process. They usually have a closed capsule bottom and an open filling side with a collar edge, onto which a lid film is sealed or adhesively bonded after the cavity of the portion capsule has been provided with a filter element and has been filled with a granular, pulverulent or liquid beverage substrate. In the case of tea, the beverage substrate can also be present as loose leaves.

The filter element is arranged between the beverage substrate and the capsule bottom and, according to this embodiment of the present invention, has an edge region, in particular a circularly annular edge region, which is fastened, in particular sealed, to the collar edge of the portion capsule. The edge region is adjoined by the side wall of the filter element which preferably runs at least in sections parallel to the side wall of the capsule body. The side wall is provided at an angle with respect to the edge region. The side wall is preferably provided in a frustoconical or parabolic manner. The side wall and/or the edge region preferably have/has folds. According to the invention, the side wall of the filter element is stretched. As a result, the filter element, in particular its wall region, is given a defined shape which has an advantageous effect on the through flow of the water through the filter and prevents the filter element from being pierced by a piercing member, in particular in the region of the capsule bottom. The side wall of the filter element adjoins a central region which preferably runs at least in sections parallel to the bottom of the capsule body and/or is situated in the region of the rotational axis of the filter element. According to the invention, the central region is connected to the capsule bottom, in particular in an integrally joined manner, for example by way of sealing, in particular using an ultrasonic tool. The sealing to the capsule bottom can be, for example, in a punctiform, full-area or circularly annular manner. The internal diameter of the sealing on the capsule bottom is preferably 0-32% and the external diameter is 7-42% of the free internal diameter of the capsule body. The side wall of the filter element is preferably stretched during fastening to the capsule bottom. The filter element is produced from a nonwoven fiber material and prevents particles of the beverage substrate passing into the beverage to be produced. The region within the respective sealing circle is as a rule not available for filtration.

The filter element can be provided in multiple layers, the layers preferably being connected to one another, for example by way of calendering.

For the production of the portion capsule according to the invention, a capsule body, for example, is provided, onto the collar edge of which the edge region of the filter element is sealed. Afterward, the central region of the filter element is sealed onto the capsule bottom, and subsequently the beverage substrate is filled into the capsule body. Subsequently, the portion capsule is closed by way of a lid film which is connected to the edge region of the filter element and/or to the collar edge of the capsule body, in particular by way of sealing. As an alternative, the filter element is connected to the capsule bottom, and is filled with the beverage substance. Finally, the lid film is sealed onto the edge region of the filter element, and the edge region of the filter element is connected to the collar edge of the portion capsule substantially at the same time. The filter element is stretched in the process. Any material of the filter element which possibly projects can be removed subsequently, in particular, for example by way of punching.

For the preparation of a beverage, for example a coffee beverage, the portion capsule is introduced into a brewing chamber of a preparation unit. After or during the closing operation of the brewing chamber, the capsule is preferably opened, with preference on its closed bottom side, by means of an opening spike which is arranged in the brewing chamber, the opening spike preferably opening the edge region of the capsule bottom. After and/or during the sealing of the brewing chamber, the filling side of the portion capsule which is closed by way of a lid film is preferably opened by means of at least one piercing means. There are also portion capsules, however, which are already open on at least one side before they are introduced into the preparation unit. Subsequently, a preparation liquid, preferably hot water, is conveyed under pressure into the portion capsule. The preparation liquid flows through the beverage substrate and extracts and/or dissolves the substances which are required fox the beverage production from the beverage substrate. For the preparation of coffee, a pump pressure of approximately two bar or less is sufficient in the case of the portion capsule according to the invention, in order to convey water through the portion capsule.

According to a further or preferred subject of the present invention, a spacer element which spaces the filter element apart from the capsule bottom and/or the side wall of the capsule body is provided in the region of the capsule bottom.

The comments made in respect of this subject of the present invention likewise apply to the other subjects of the present invention, and vice versa.

The spacer element is preferably a cylindrical and/or conical and/or circularly annular hollow body, the side walls of which are preferably perforated. The spacer element preferably provides no flow resistance or only very low flow resistance for the finished beverage. The spacer element prevents, for example, a piercing member damaging the filter element. The central region of the filter element is received, for example, in the circular ring and is therefore spaced apart from the capsule edge in sections. As an alternative or in addition, the filter element lies, for example, on the spacer element, as a result of which it is spaced apart from the capsule bottom. The spacer element is preferably produced from plastic. The spacer element can be connected to the capsule bottom in a positively locking, non-positive and/or integrally joined manner. The filter element can be connected to the spacer element and/or to the capsule bottom in a positively locking, non-positive and/or integrally joined manner. For the case where a spacer element is used, stretching of the side wall of the filter element is preferably dispensed with. The spacer element is preferably provided between the filter element and the capsule body.

A further subject of the present invention is a portion capsule for producing a beverage having a capsule body with a capsule bottom, a side wall and a collar edge and a lid, a cavity for receiving a pulverulent, granular or liquid beverage substrate being configured between the capsule bottom and the lid, and a filter element being arranged in the cavity, and the filter element being produced from nonwoven fiber material, an element, for example an annular element, being provided in the cavity, which element connects an edge region of the filter element to the side wall of the capsule body in a positively locking, non-positive and/or frictionally locking manner. The positively locking and/or non-positive connection preferably takes place by way of a groove/tongue connection, the groove particularly preferably being situated in the side wall of the capsule body and the tongue being situated in the element, in particular in the annular element. A person skilled in the art understands that the element can also have the groove, however. The frictionally locking connection can take place between the element and the side wall of the capsule body or between the filter element and the side wall of the capsule body, the element preferably stretching the filter element against the capsule body in the latter case. The element is preferably designed as a frustoconical ring. The filter element is preferably connected to the annular element in an integrally joined manner. The annular element can also be provided in a pocket of the filter element, however. The element is preferably arranged within the filter element on the side which faces the product. The connection between the annular element and the side wall of the capsule body preferably represents a seal which prevents liquid from flowing past the filter element during brewing. This sealing action can be improved further by way of the water pressure, by the water pressure displacing the ring parallel to the side wall of the capsule body.

The comments made in respect of this subject of the present invention likewise apply to the other subjects of the present invention, and vice versa.

In this embodiment of the portion capsule, the central region of the filter element is preferably connected to the capsule bottom. This particularly preferably takes place by way of sealing of the filter element onto the capsule bottom.

Furthermore, the side wall of the filter element is also preferably stretched in this embodiment. The positively locking, non-positive and/or frictionally locking connection between the annular element and the side wall of the capsule body is preferably improved by way of the stretching.

A constituent part of the filter element is preferably paper and/or a naturally occurring material and/or a biologically degradable plastic and/or a plastic made from a renewable raw material.

The filter element is preferably of elastic configuration. As a result, the side wall of the filter element can be stretched and acts like a spring. As a result, a dimensional change of the filter element under the pressure of the liquid is at least reduced.

According to one preferred embodiment of the present invention, the filter element is formed from a flat material. Said forming takes place, in particular, under pressure and/or the influence of temperature.

A lid film is preferably sealed onto the filter element. This embodiment plays a role, in particular, in the embodiment, in which the edge of the filter element is fastened to the collar edge of the capsule body.

The filter element is preferably formed and/ox fastened to the capsule body in such a way that the filter element remains imperforated during a perforation of the capsule bottom by way of an external perforation means.

The filter element is preferably sealed onto the capsule bottom, the sealing seam preferably being provided in a circular or circularly annular manner. The mean diameter of the circular ring or the external diameter is preferably 5-36% of the circle, in each case in relation to the greatest external diameter of the capsule body and/or the width of the sealing seam 0.5-2 mm.

The filter area is preferably between 1100 and 4300 mm², particularly preferably between 1500 and 1900 mm².

The capsule body is preferably formed in a frustoconical or cylindrical manner and is produced, for example, from plastic, a natural substance and/or a biologically degradable material and/or a metallic material, from a deep-drawn plastic film or using the plastic injection molding process. The material, from which the capsule body is produced, can be provided in multiple layers. Preferably or according to the invention, the capsule body has a collar edge on the filling side, onto which collar edge a lid film is sealed or adhesively bonded directly or indirectly. As an alternative, it is conceivable that the capsule body and a capsule lid are connected to one another by means of a mechanical method. The bottom of the portion capsule is preferably closed and is preferably not perforated until in the brewing chamber by means of a perforation means which acts or the portion capsule bottom from the outside in order to produce an outlet opening. As an alternative, however, it would likewise be conceivable that the bottom of the portion capsule is already provided at the factory with an outlet opening which is preferably closed by means of a sealing film. The sealing film can then be perforated, for example, by means of the perforation means, or can be pulled off from the capsule bottom by hand. The filter element is preferably of tear-resistant configuration. The sealing film is preferably a plastic film which has at least one barrier layer, for example a metal layer, in particular an aluminum layer or an aluminum oxide layer. As an alternative, a pure plastic film with a barrier layer for the flavoring agent of the beverage to be produced can be used as sealing film. The plastic film preferably has a “peel layer” on its side which faces the capsule, in order for it to be possible to detach the plastic film from the capsule bottom in a comparatively easy manner.

The outlet opening is preferably provided so as to be so great that it can receive a possibly present perforation means without contact. The outlet opening is particularly preferably provided so as to be so great that no appreciable pressure loss is produced at it while the finished beverage is flowing out, in particular that no appreciable swirling of the finished beverage occurs which might lead to an entrainment of gas in the beverage and therefore to the formation of foam.

As an alternative, the material of the capsule bottom bears against the piercing means after the piercing operation. The finished beverage runs between the piercing means and the material into the capsule. A targeted pressure loss and/or targeted swirling which generates a “crema” in the coffee are/is produced here.

It is provided according to a further embodiment, according to the invention or preferred, of the present invention that the filter element is fastened to the capsule body or to the collar edge, the filter element being fastened, in particular, by way of sealing or adhesive bonding. Slipping of the filter element in the portion capsule is therefore advantageously prevented. Furthermore, this prevents the liquid from flowing around the filter element in an undesired manner. Said fastening preferably takes place by way of ultrasonic welding.

Furthermore, the filter element can preferably be sealed onto the side wall of the capsule body. The side wall of the filter element is also preferably stretched in this embodiment.

Exemplary embodiments of the invention are shown in the figures and are described in greater detail in the following description. The figures are described merely by way of example and do not restrict the general concept of the invention. The description applies equally to all subjects of the present invention.

In the drawing:

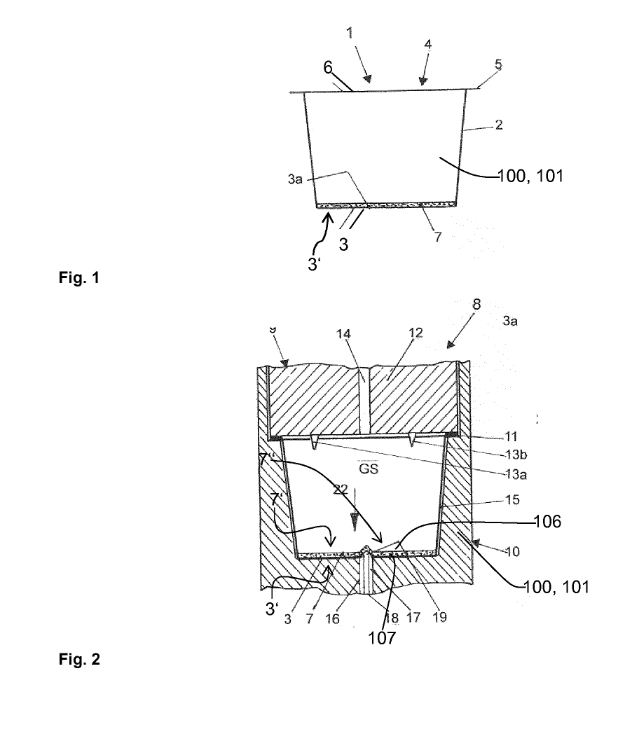

FIG. 1 shows a longitudinal section through a portion capsule in accordance with the prior art, which portion capsule is set up for the preparation of espresso,

FIG. 2 shows a longitudinal section through a portion capsule in accordance with the embodiment according to FIG. 1, which portion capsule lies in a closed brewing chamber, and

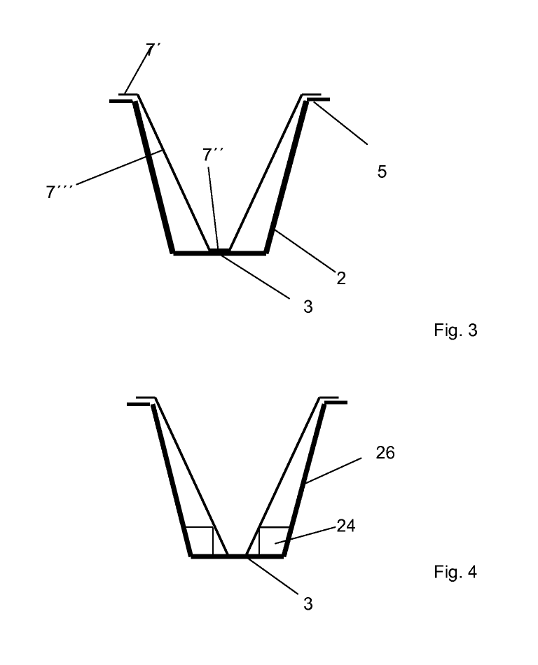

FIGS. 3-5 in each case show the portion capsule according to the invention.

In the various figures, identical parts are always provided with the same designation and are therefore also as a rule named or mentioned in each case only once.

FIG. 1 shows one embodiment of a portion capsule 1 in accordance with the prior art. The portion capsule 1 comprises a frustoconical capsule body 2 with a closed capsule bottom 3 and with a collar edge 5 which is arranged on a filling side 4 and onto which a lid film 6 is welded or adhesively bonded. A cavity 100 which is preferably closed in an air-tight and aroma-tight manner is therefore configured between the capsule bottom 3 and the lid film 6, which cavity 100 is filled with a pulverulent and/or granular beverage substance 101. Here, the beverage substance 101 comprises, for example, a coffee, cocoa, tea and/or milk powder (or granulate). A filter element 7, consisting of a nonwoven fiber material, is arranged on the inner side 3a of the closed capsule body bottom 3, that is to say within the cavity 100. In the case of the portion capsule according to the invention, the filter element is not flat and will be explained using FIGS. 3-5.

FIG. 2 shows a portion capsule 1 according to FIG. 1, the portion capsule 1 being arranged in a closed brewing chamber 8 in FIG. 2. The brewing chamber 8 consists of a first bearing chamber element 9 and a second brewing chamber element 10, the first brewing chamber element 9 being arranged so as to be movable with respect to the second brewing chamber element 10 or vice versa, in order to introduce the portion capsule 1. A seal 11 is arranged between the two brewing chamber elements 9, 10. The first brewing chamber element 9 consists substantially of a closing piston 12 with piercing elements 13a, 13b for opening the lid film 6 of the portion capsule 1, a preparation liquid supply 14 and a seal 11. The second brewing chamber element 10 consists substantially of a brewing chamber bell 15 which partially encloses the portion capsule 1, with an opening spike 16 which is arranged on the bottom of the brewing chamber bell 15 and is provided with run-out grooves 17, and a beverage outlet 18. In order to receive the portion capsule 1, the brewing chamber 8 is situated in an open state (not shown), in which the first and the second brewing chamber element 9, 10 are spaced apart from one another, in order to ensure feeding in of the portion capsule 1, and the closed state which is shown and in which a preparation operation for producing a beverage by means of the portion capsule 1 can be carried out. In the closed state, the brewing chamber 8 is closed in a pressure-tight manner. During the transfer of the brewing chamber 8 from the open state into the depicted closed state, the lid film 6 is pierced by the piercing elements 13a, 13b, with the result that preparation liquid, in particular hot brewing water, passes through the preparation liquid supply 14 under pressure into the cavity 100 of the portion capsule 1. Furthermore, during closing of the brewing chamber 8, the capsule bottom 3 is perforated by the perforation means which is configured as an opening spike 16, with the result that an outlet opening 107 is produced in the portion capsule 1, through which outlet opening 107 the produced beverage liquid can exit from the portion capsule 1 in the direction of the beverage outlet 18. In order to assist the discharge of the beverage liquid, the opening spike 16 has the run-out grooves 17 on its outer face. The capsule bottom 3 optionally has a predetermined break point 104 at its central point 106, at which the capsule bottom 3 is perforated by the opening spike 16, with the result that a comparatively blunt opening spike 16 is sufficient for perforating the capsule bottom 3, and thus the risk that the filter element 7 is also accidentally perforated by the opening spike 16 is eliminated.

FIGS. 3-5 in each case show one embodiment of the portion capsule according to the invention. The filter element preferably comprises a nonwoven which is produced from fine polyester fibers and has a mass distribution between 10 and 100 g/m², preferably between 20 and 40 g/m² and particularly preferably of substantially 25-35 g/m² and/or which has a thickness between 0.05 and 0.3 mm, preferably between 0.1 and 0.2 mm and particularly preferably of substantially 0.12-0.16 mm and/or which has an air permeability at a pressure of 100 Pascal of between 2500 and 5000 l/(m²s), preferably between 3000 and 4000 l/m²s) and particularly preferably substantially at 3200-3400 l/(m²s). The filter element 7 is produced from a flat material which has been changed into a three-dimensional shape under pressure and/or the influence of temperature.

In the embodiment according to FIG. 3, the filter element has an edge region 7′ which is adjoined by a sidewall 7′″ which is conical here. In the middle, the filter element 7 has a central region 7″. The edge region 7′ is connected to the edge region 5 of the capsule body, for example, by way of sealing. The same applies to the central region 7″ which is connected to the bottom of the capsule body. According to the invention, the side wall 7′″ of the filter element is stretched. In the present case, the filter element is formed in such a way that a cavity is produced between the bottom and the filter element, into which cavity a piercing means can penetrate, without the filter element being damaged. The portion capsule according to the invention is produced, for example, by the filter element 7 first of all being connected to the edge region 5 of the capsule body. Afterward, the central region of the filter element is connected to the bottom 3 of the capsule. Here, the filter element is formed and/or stretched. The beverage substance is then filled into the portion capsule, and finally the portion capsule is closed by way of a lid film which is sealed, for example, onto the edge region of the filter element.

FIG. 4 shows substantially the embodiment in accordance with FIG. 3, a spacer element 24 being provided in the region of the bottom of the capsule body in the present case, which spacer element 24 spaces the filter element away from the bottom and/or from the side wall 26 of the capsule body. The spacer element is, for example, a circular annular body, in particular a hollow body. The filter element can be sealed onto the spacer element and/or onto the bottom of the capsule body.

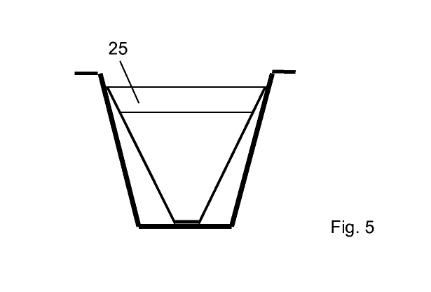

FIG. 5 shows another embodiment of the portion capsule according to the invention. In the present case, an element 25 is provided which is preferably of annular configuration with a frustoconical side wall. The filter element 7 is connected to the element 25, for example, in an integrally joined manner. The element 25 bears against the side wall of the capsule body and forms a positively locking, non-positive, integrally joined connection with the latter. In particular, the connection is frictionally locking. The central region of the filter element is preferably connected to the capsule bottom. The side walls of the filter element can be stretched.

### LIST OF DESIGNATIONS

1 Portion capsule
2 Capsule body
3 Capsule bottom
3a Capsule bottom inner side
3′ Edge region of the capsule bottom
4 Filling side
5 Collar edge
6 Lid, lid film
7 Filter element
7′ Edge region of the filter element
7″ Central region of the filter element
7′″ Side wall of the filter element
8 Brewing chamber
9 First brewing chamber element
10 Second brewing chamber element
11 Seal
12 Closing piston
13a Piercing element
13b Piercing element
14 Preparation liquid supply
15 Brewing bell
16 Opening spike
17 Run-out grooves
18 Outlet
19 Piercing tip
20 Recess
21 Recess/bulge
22 Preparation liquid flow
23 Brewing bell bottom
24 Spacer element
25 Stretching element
26 Side wall of the capsule body
100 Cavity
101 Beverage substrate
106 Central point
107 Opening, outlet opening

1. A portion capsule for producing a beverage having a capsule body with a capsule bottom, a side wall and a collar edge and a lid, a cavity for receiving a pulverulent granular or liquid beverage substrate being configured between the capsule bottom and the lid, and a filter element being arranged in the cavity, and the filter element being produced from nonwoven fiber material, wherein the filter element has an edge region which is fastened to the collar edge of the capsule body and has a central region which is fastened to the capsule bottom, the side wall of the filter element being stretched.

2. The portion capsule as claimed in claim 1, wherein a spacer element provided in a region of the capsule bottom, and wherein the spacer element spaces the filter element apart from the capsule bottom, and/or the side wall the capsule body.

3. A portion capsule for producing a beverage having a capsule body with a capsule bottom, a side wall and a collar edge and a lid, a cavity for receiving a pulverulent or liquid beverage substrate being configured between the capsule bottom and the lid, and a filter element being arranged in the cavity, and the filter element being produced from nonwoven fiber material, wherein an annular element is provided in the cavity, wherein the annular element connects an edge region of the filter element to the side wall of the capsule body in a positively locking, non-positive and/or frictionally locking manner.

4. The portion capsule as claimed in claim 3, wherein a central region of the filter element is connected to the capsule bottom.

5. The portion capsule as claimed in claim 3, wherein the side wall of the filter element is stretched.

6. The portion capsule as claimed in claim 1, wherein one constituent part of the filter element is paper.

7. The portion capsule as claimed in claim 1, wherein the filter element is a nonwoven and/or has a felt structure.

8. The portion capsule as claimed in claim 7, wherein the nonwoven comprises a nonwoven fabric which is produced from fine polyester fibers, and/or in that the nonwoven has a mass distribution between about 10 and about 100 g/m², and/or in that the nonwoven has a thickness between about 0.05 and about 0.3 millimeters, and/or in that the nonwoven has an air permeability at a pressure of 100 Pascal of between about 2500 and about 5000 l/(m²s).

9. The portion capsule as claimed in claim 1, wherein the filter element is provided at least partially from a biologically degradable plastic.

10. The portion capsule as claimed in claim 1, wherein the filter element is of elastic configuration.

11. The portion capsule as claimed in claim 1, wherein the filter element is formed from a flat material.

12. The portion capsule as claimed in claim 1, wherein a lid film is sealed onto the filter element.

13. The portion capsule as claimed in claim 1, wherein the capsule bottom is configured in such a way that the filler element remains imperforated when the capsule bottom is perforated by way of an outer perforation means.

14. The portion capsule as claimed in claim 1, wherein the filter element is sealed onto the capsule bottom at a sealing seam, the sealing seam being provided in a circularly annular manner forming a circular ring.

15. The portion capsule as claimed in claim 14, wherein a mean diameter of the circular ring is about 3- to about 18 mm and/or a width of the sealing seam is about 0.5- to about 2 mm.

16. The use of a portion capsule as claimed in claim 1 for producing a coffee, cocoa, tea and/or milk beverage.

17. The portion capsule as claimed in claim 8, wherein the mass distribution of the nonwoven is between about 25 and about 35 g/m².

18. The portion capsule as claimed in claim 8, wherein the thickness of the nonwoven is between about 0.12 and about 0.16 millimeters.

19. The portion capsule as claimed in claim 8, wherein the air permeability of the nonwoven at a pressure of 100 Pascal of between about 3200 and about 3400 l/(m²s).
